(19) United States
(12) Patent Application Publication
(10) Pub. No.: US 2004/0132412 A1
(43) Pub. Date: Jul. 8, 2004

(54) Tone frequency signaling

(76) Inventors: Mark L. Plett, Redmond, WA (US); Rand W. Lee, Kirkland, WA (US)

Correspondence Address: Todd M. Becker, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/338,492

(22) Filed: Jan. 7, 2003

(51) Int. Cl. H04B 10/00; H04B 11/00; H04B 1/00; H04B 7/00; H04B 1/38

(52) U.S. Cl. 455/69; 455/68; 379/56.1

(57) ABSTRACT

This application disclosed an apparatus and process for tone frequency signaling. The apparatus comprises a transmitter to transmit a first signal, the first signal comprising a first data signal modulated onto a first carrier tone, a receiver to receive a second signal and monitor a characteristic of the second signal, the second signal comprising a second data signal modulated onto a second carrier tone, and a controller coupled to the transmitter and the receiver to change the frequency of the first carrier tone from a first frequency to a second frequency in response to the monitored characteristic of the second signal. The process comprises transmitting a first signal, the first signal comprising a first data signal modulated onto a first carrier tone, receiving a second signal, the second signal comprising a second data signal modulated onto a second carrier tone, monitoring a characteristic of the second signal, and changing the frequency of the first carrier tone from a first frequency to a second frequency in response to changes in the monitored characteristic of the second signal. Other embodiments are described and claimed.

### TECHNICAL FIELD

The present invention relates generally to free-space optical communication systems and in particular, but not exclusively, to free-space optical communication systems including auxiliary signaling via a tracking tone.

### BACKGROUND

With the increasing popularity of wide area networks, such as the Internet and/or the World Wide Web, network growth and traffic have exploded in recent years. Network users continue to demand faster networks, and as network demands continue to increase, existing network infrastructures and technologies are reaching their limits.

An alternative to existing hardwire or fiber network solutions, which suffer from limited capacity or exponentially increasing construction costs in “the last mile” of the communication system, is the use of wireless optical telecommunications technology. Wireless optical telecommunications utilize beams of light, such as lasers, as optical communication signals, and therefore do not require the routing of cables or fibers between locations. Data, or other information, is encoded into a beam of light, and then transmitted through free space from a transmitter to a receiver.

A typical free-space optical communication system allows two-way data communication, and thus includes at least two corresponding pairs of transmitters and receivers. Often, a transmitter and a receiver are paired together in a single unit to form a transceiver; the communication system then operates as a set of paired transceivers. In operation, each transceiver must monitor its own internal operation to ensure that it is functioning properly and optimally. One transceiver does not a system make, however, so for proper operation of the system as a whole it is advantageous if, in addition to monitoring its own functions, each transceiver in the pair can receive information about how the other transceiver is operating.

Existing approaches to enabling transceivers to communicate their operational status to each other have focused on introducing the operational data into the primary data stream carried by the transceivers. Essentially, then, each transceiver modulates its operational information onto the existing optical data signal it is already transmitting. This approach, however, suffers from various problems. Most importantly, because it relies on the actual transmission of data, the signal strength must be adequate if the operational data is to be properly communicated to the other transceiver. There is therefore a need in the art for an apparatus and process that allows a pair of transceivers to communicate in situations where the power may be too low for actual data transmission.

### SUMMARY OF THE INVENTION

This application discloses an apparatus and process for tone frequency signaling. The apparatus comprises a transmitter to transmit a first signal, the first signal comprising a first data signal modulated onto a first carrier tone, a receiver to receive a second signal and monitor a characteristic of the second signal, the second signal comprising a second data signal modulated onto a second carrier tone, and a controller coupled to the transmitter and the receiver to change the frequency of the first carrier tone from a first frequency to a second frequency in response to the monitored characteristic of the second signal.

The process comprises transmitting a first signal, the first signal comprising a first data signal modulated onto a first carrier tone, receiving a second signal, the second signal comprising a second data signal modulated onto a second carrier tone, monitoring a characteristic of the second signal, and changing the frequency of the first carrier tone from a first frequency to a second frequency in response to changes in the monitored characteristic of the second signal. Other embodiments are described and claimed.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic showing an embodiment of a free-space optical communication system.

FIG. 2 is a schematic showing an embodiment of a controller useable in the transceivers of FIG. 1.

FIG. 3 is a state drawing showing an embodiment of the operation of the controller of FIG. 2.

FIG. 4 is a schematic drawing showing an embodiment of a transmitter useable in the transceiver embodiment of FIG. 2.

FIG. 5 is a schematic drawing of a receiver including a quad-cell detector that can be used in the transceivers of FIG. 1.

FIG. 6 is a schematic drawing showing an embodiment of a receiver useable in the transceivers of FIG. 1.

### DETAILED DESCRIPTION OF THE ILLUSTRATED EMBODIMENTS

Embodiments of a system and method for tracking tone frequency signaling in free-space optical communication system are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily refer to the same embodiment. Furthermore, the particular features, structures, or characteristics may be combined in any suitable manner in one or more embodiments.

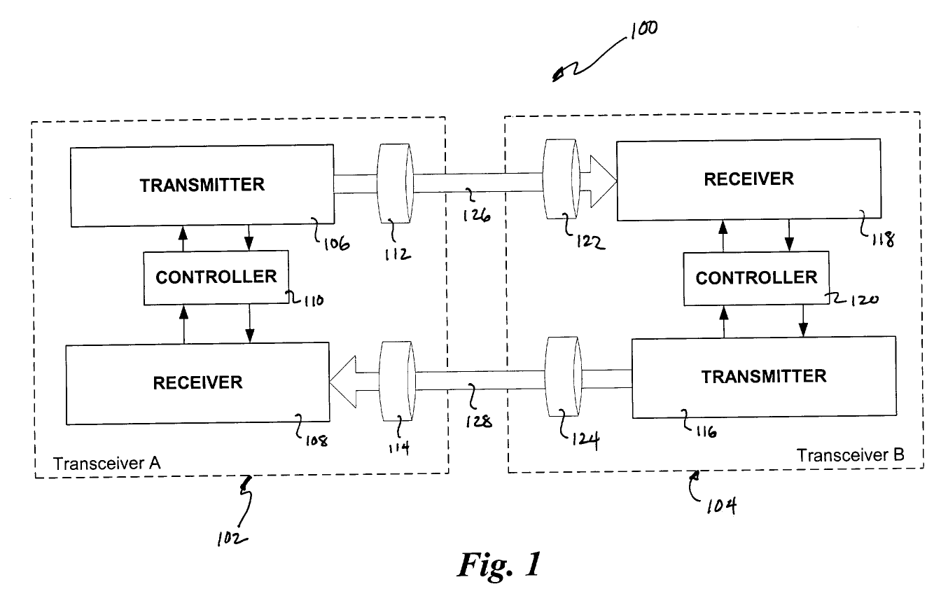

FIG. 1 illustrates an embodiment of the invention comprising a free-space optical communication system 100. Although discussed herein in terms of a free-space optical communication system, the invention can equally well be embodied in other types of communications systems such as optical-fiber-based systems, millimeter-wave systems, etc. The system 100 comprises a first transceiver 102 and a second transceiver 104. The first transceiver 102 comprises a transmitter 106, a receiver 108, and a controller 110 operatively coupled to both the transmitter and the receiver. Transceiver 102 also includes a receiving objective 114 coupled to the receiver 108 and a transmitting objective 112 coupled to transmitter 106. The objectives 112 and 114 each comprise one or more elements that can focus and/or collimate an optical signal. The objectives can comprise lenses, mirrors, or combinations of the two. Similarly, the second transceiver 104 comprises a transmitter 116, a receiver 118, a controller 120 operatively coupled to the transmitter and the receiver, and objectives 122 and 124. In the embodiment shown, the transmitters and receivers are shown as separate units, although in other embodiments the two could be combined into a single unit. Similarly, in the embodiments of the transceivers 102 and 104, the transmission and reception take place through different optics, although in alternative embodiments the optics could be combined so that transmission and reception both take place through the same optics.

In operation of the transceiver 102, the transmitter 106 takes one or more signal inputs (not shown), converts them into a first optical signal 126, and transmits the first optical signal into free space through the objective 112. Similarly, a second optical signal 128 is received at the second objective 114 and routed to the receiver 108, which processes the information contained in the second optical signal 128. The transceiver 104 works similarly, so that the transceivers 102 and 104 exchange optical signals: in the transceiver 102, the transmitter 106 transmits a first optical signal 126, whilst the receiver 108 receives a second optical signal 128. Conversely, in the transceiver 104, the transmitter 116 transmits the second optical signal 128 whilst the receiver 118 receives the first optical signal 126. Both the first and second optical signals can comprise one or more superimposed signals. In one embodiment, the first and second optical signals comprise a carrier tone on which is superimposed a data signal. Additional signals, such as an auxiliary data signal, may optionally be superimposed on the carrier tone as well.

The controllers 110 and 120 operatively couple the transmitters to the receivers and control some aspects of both, so that in each transceiver characteristics of the transmitted signal, such as the signal strength or power, can be controlled or modified in response to characteristics of the received optical signal.

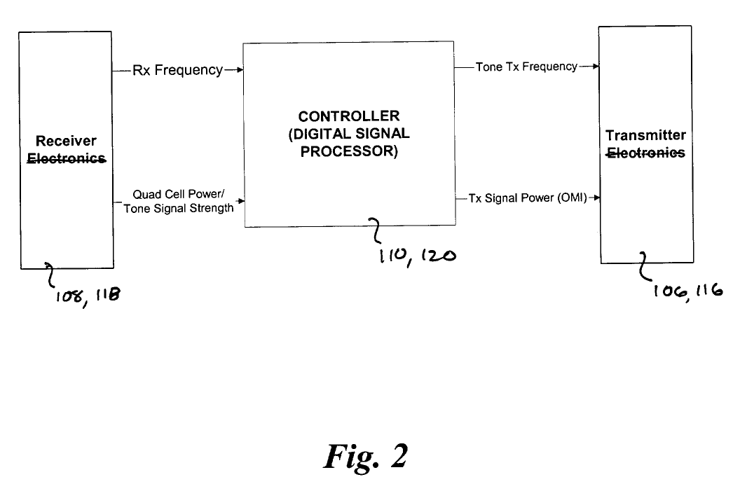

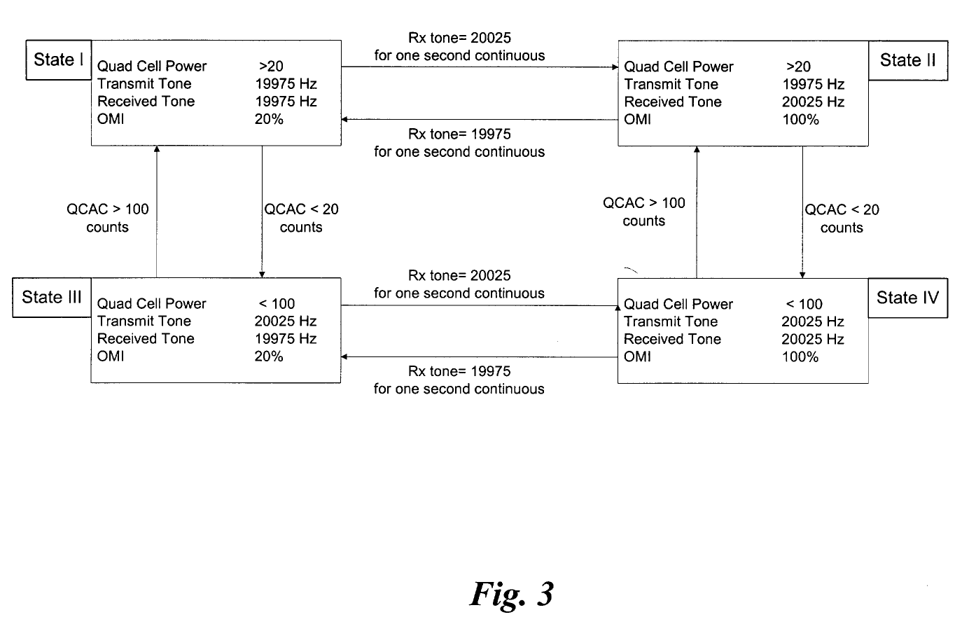

FIGS. 2 and 3 together illustrate an embodiment of the controller 110 and its operation; controller 120 operates similarly. Since transceivers usually work together as a pair, for proper operation each transceiver must be able to assess not only its own operation, but also the operation of the transceiver with which it is paired (its “paired transceiver”). To accomplish this, each transceiver must be able to monitor its own internal operation and to transmit to its paired transceiver information about its operation, so that the paired transceiver can adjust its operation if necessary. Using the transceiver 102 (see FIG. 1) as an example, the transceiver monitors one or more characteristics of the received optical signal (e.g., the second optical signal 128) and can modify one or more characteristics of its transmitted optical signal (e.g., the first optical signal 126) if required under certain conditions.

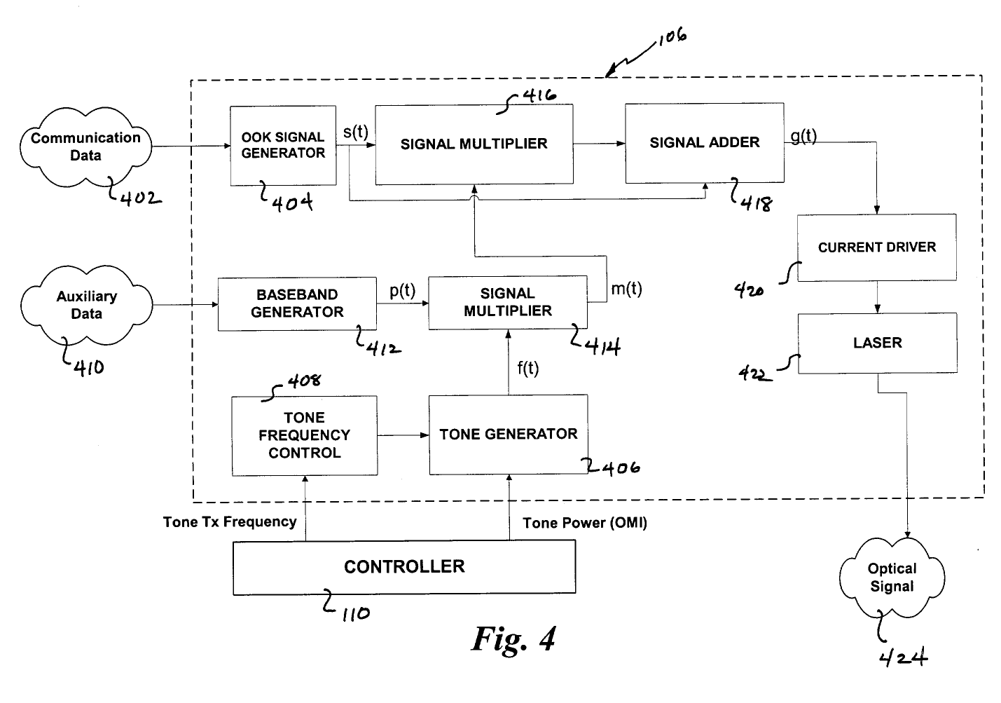

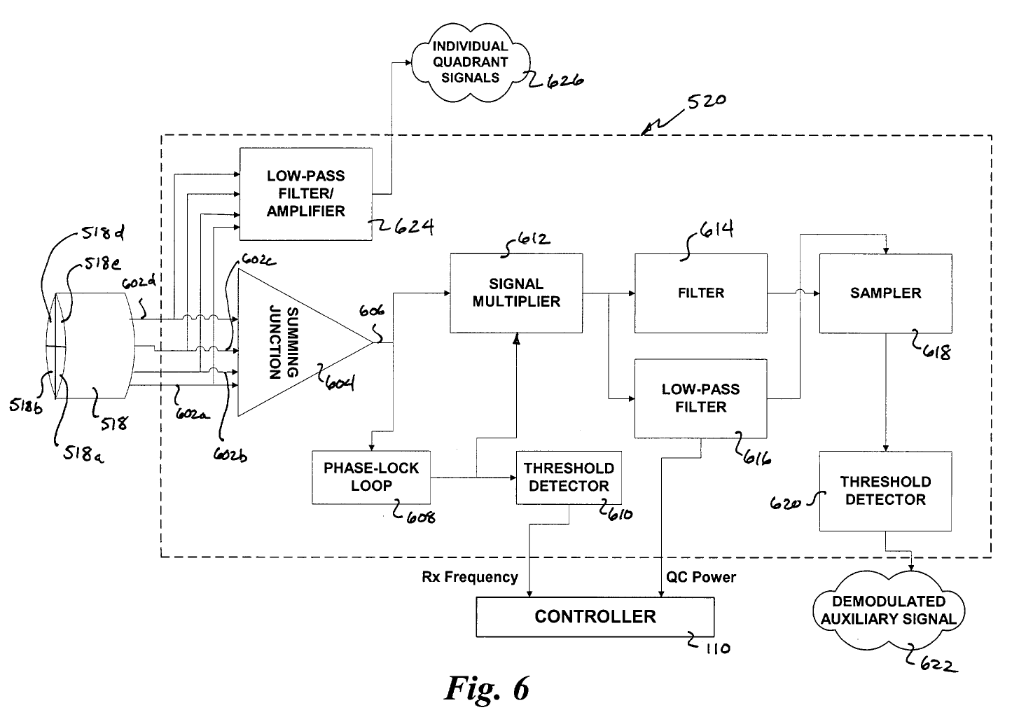

In one embodiment, the controller 110 comprises a digital signal processor that receives certain inputs from the receiver and, in response, sends certain outputs to the transmitter. The controller 110 receives as input the frequency of the received carrier tone and the strength (e.g., the power or amplitude) of the received optical signal (see FIG. 6). In response to the measured characteristics of the received signal and tone, the controller outputs a tone transmission frequency and an optical signal power. The optical signal power is output as an Optical Modulation Index (OMI) which essentially controls the amplitude A of the carrier tone f(t) (see FIG. 4).

FIG. 3 illustrates an embodiment of the operation of the controller 110 using a state diagram. The diagram illustrates the four states in which a pair of transceivers can be found during operation as shown, for example, in FIG. 1. For reference, the four states are labeled I, II, III and IV, although the states need not occur in any particular order and no order should be inferred.

In the embodiment shown, to assess its own operation each transceiver 102 and 104 monitors the power of the received optical signal to determine whether it has sufficient power for proper reception. If the power of the received signal exceeds a certain threshold power operation is deemed acceptable, but if the power of the received signal falls below a certain threshold then operation is deemed unacceptable. In some cases, there may actually be two different thresholds, so that adjustments are not constantly being made if the received power fluctuates constantly about a single threshold. For example, in the embodiment shown the thresholds are set as follows:

| QUAD CELL POWER | |
|---|---|
| (QCAC) | STATUS |
| QCAC > 100 | sufficient power -- |
| | change frequency |
| 20 < QCAC < 100 | no changes |
| QCAC < 20 | insufficient power -- |
| | change frequency |

To assess the operation of its paired transceiver, each transceiver monitors the frequency of the tone carried in the received optical signal to assess the state of its paired transceiver. To transmit information regarding its own operation to its paired transceiver, each transceiver can transmit information about its own operation by changing the frequency of the tone it transmits in the optical signal.

In state I, both transceivers are receiving enough signal power. The transceiver 102 receives a quad cell power (QCAC) exceeding 20 counts, which signals to the transceiver that its own operation is okay that is, it is receiving enough power for operation. To signal to its paired transceiver 104 that it is receiving enough power, the transceiver 102 transmits a tone at a first frequency, in this case 19975 Hz. Finally, the transceiver 102 receives a tone from its paired transceiver 104 at the first frequency of 19975 Hz, which signals to the transceiver 102 that its paired transceiver is also receiving sufficient power and operating properly. Since both transceivers are operating properly, the controller makes no adjustments and the transceivers remain in state I.

In state II, the transceiver 102 is receiving enough power, but its paired transceiver 104 is not. The quad cell power at the transceiver 102 remains above a threshold of 20 counts, indicating that it continues to receive adequate signal power from the paired transceiver 104. Since the transceiver 102 is receiving adequate signal strength, it continues to transmit a tone at the first frequency, indicating to the paired transceiver 104 that the power reception is adequate. The frequency of the tone received from the paired transceiver 104, however, has changed to a second frequency, in this case 20025 Hz, although other frequencies are possible. In this embodiment, the second frequency is greater than the first, but in other embodiments the second frequency may be lower. The change in frequency of the received tone signals to the transceiver 102 that its paired transceiver 104 is receiving insufficient signal power and needs more. In response, the transceiver 102 increases its power output by increasing its Optical Modulation Index (OMI) to 100%. If after the transceiver 102 increases its OMI the paired transceiver 104 has enough power, the paired transceiver changes the frequency of its transmitted tone—and thus the frequency of the tone received at the transceiver—back to the first frequency and the transceiver returns to state I, as shown by the arrows in the figure.

In state III, the transceiver 102 needs power, but the paired transceiver 104 is operating properly. The quad cell power of transceiver 102 drops below a threshold of 100 counts, indicating that insufficient signal power is being received. The transceiver thus changes the frequency of the transmitted tone to the second frequency of 20025 Hz to indicate to the paired transceiver that more power is needed. At the same time, the received tone is at the first frequency of 19975 Hz, indicating that the paired transceiver is receiving enough power; thus the OMI need not be changed from its existing setting of 20%.

In state IV, both the transceiver 102 and its paired transceiver 104 need additional power. The quad cell power of transceiver 102 has dropped below a threshold of 100 counts, meaning that it is not receiving enough power for proper operation. The transceiver 102 thus changes its tone to the second frequency of 20025 Hz to signal to its paired transceiver 104 that it needs more power. Generally, this shift in tone frequency between the first frequency and the second frequency will occur at a rate that is low enough that the phase-lock loop on the paired transceiver 104 (see FIG. 6) will not lose its lock on the frequency of the tone. At the same time, the tone received from the paired transceiver 104 is also at the second frequency of 20025 Hz, indicating that the paired transceiver also needs more power. In response, the transceiver boosts its OMI to 100%. If after the transceiver 102 and its paired transceiver 104 increase their OMI both transceivers have enough power, both transceivers change the frequency of their transmitted tone back to the first frequency and the transceivers return to state I, as shown by arrows in the figure.

FIG. 4 illustrates an embodiment of transmitter 106 for generation and transmission of an optical signal comprising a carrier tone superimposed on a data communication signal. A phase-modulated auxiliary signal can optionally be modulated onto the carrier tone and combined with the data communication signal. The process of generating and transmitting an optical signal 424, implemented by the transmitter 106, begins with the encoding of a primary communication data set 402 into a primary digital signal s(t). The primary digital signal s(t) can be generated from the primary data set by an OOK signal generator 404, or by some other type of encoding scheme. The primary digital signal s(t) comprises a high-speed signal, e.g., 1.25 Gbps, and may vary within the megahertz or gigahertz range, for example. In conjunction with the encoding of the primary data set 402, a carrier tone f(t) is produced by a tone generator 406 for later combination with the primary digital signal s(t). The carrier tone has an amplitude A and frequency ω₁ and in one embodiment is of the form f(t)=A cos(ω₁t), although other types of signals may be used in other embodiments, such as square waves, triangle waves, and the like. The frequency ω₁ of the tone signal f(t) is controlled by a tone frequency control 408 based on input received from the controller 110. The tone frequency control 408 can set the tone frequency at any of a plurality of values within a specified range and subsequently maintain the frequency of the tone at that value. Additionally, the tone frequency control can change the frequency of the tone during operation of the electronics. Changes in the frequency of the tone during operation are accomplished at a pre-determined rate, which will usually be slow enough that the phase-lock loop in the receiver (see FIG. 6) will not lose its lock on the tone.

The amplitude A of the tone signal f(t), and hence its power, is determined in the tone generator 406 based on input from the controller 110. The controller 110 provides the amplitude information to the tone generator in the form of an Optical Modulation Index (OMI). By choosing an amplitude A for the carrier tone f(t) that is within the range of 5-10 percent of the amplitude of the primary digital signal s(t) in an embodiment, the phase-modulated carrier signal m(t), encoded with the auxiliary digital signal p(t), has a minimal effect on the primary digital signal s(t), as contained in the data communication signal s(t), thereby ensuring that the primary high speed data is not compromised in the transmission process by the incorporation of lower-rate auxiliary data. Although a 5-10 percent modulation depth is used in one embodiment, higher or lower modulation depths may be used, depending on the particular application, on the sensitivity of the optical communication system to variations in peak amplitude, on the permissible amount of data loss or data distortion, or other considerations.

An auxiliary data set 410 can optionally be encoded into an auxiliary digital signal p(t) by a baseband generator 412 for subsequent combination with the primary digital signal s(t) and the carrier tone f(t). If and when present, the auxiliary digital signal has a lower data rate than the primary signal s(t) (e.g., 10 kbps), and may vary within a frequency of 10 Hz to 100 kHz, for example. When present, the auxiliary digital signal p(t) can be combined with the carrier tone f(t) in a first modulator circuit, such as a first signal multiplier 414, to produce a phase-modulated carrier signal m(t), wherein m(t)=p(t) f(t).

The phase-modulated carrier signal m(t) can be produced using phase-shift keying of a sinusoidal tone, in this case the carrier tone f(t). Phase-shift keying transforms the auxiliary digital signal p(t) into the analog phase-modulated carrier signal m(t). As indicated previously, other modulation techniques may also be utilized, including, but not limited to, amplitude-shift keying, frequency-shift keying, and the like. In cases where no auxiliary data is encoded using the baseband generator 412, p(t) is not present and m(t)=f(t).

The phase-modulated carrier signal m(t) is then combined with the primary digital signal s(t) in a second modulator circuit such as a second signal multiplier 416, and the resulting product signal is input to a third modulator circuit such as a signal adder 418, where the product signal is combined with the primary digital signal s(t) to produce a data communication signal g(t) with the phase-modulated carrier signal m(t) superimposed thereon, wherein

g(t)=s(t)[1+m(t)].

The generated data communication signal g(t) is then input into a current driver 420 that drives a laser 422 with a modulated signal in the form of the data communication signal g(t) to produce a modulated laser output that is directed through an optical fiber (not shown) to a free-space optical transmitter to produce an optical signal 424 representing the data communication signal g(t) that includes the encoded information contained in the primary data set 402 and, if and when present, the auxiliary data set 410. The optical signal 424 may comprise laser light in the range of 1550 nm, for example.

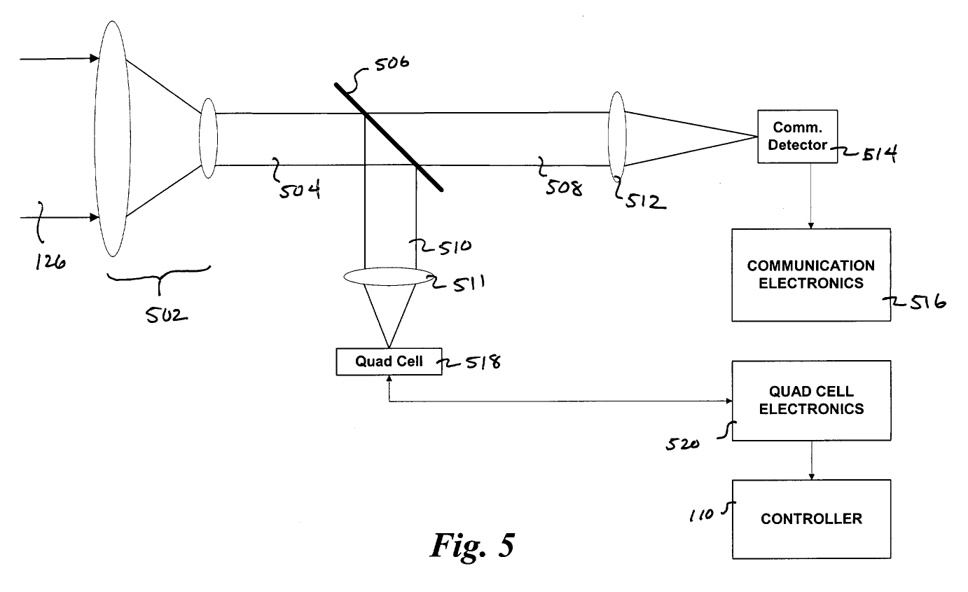

FIG. 5 illustrates an embodiment of the optical receiver 118 that uses a quad cell detector to receive, de-modulate and decode an optical signal comprising a carrier tone, a primary data communication signal and, optionally, an auxiliary data signal; the optical receiver 108 would function similarly.

The optical receiver 118 uses a quad cell detector for tracking and auxiliary functions and a communication for receiving and extracting a communication signal. The optical signal 126 is received by an optical objective 502, which in the embodiment shown comprises a combination of lenses, but in other embodiments can be other combinations of lenses, arrangements of mirrors, or arrangements of lenses and mirrors designed to collect and focus light. The optical signal 126 is focused and collimated by the objective 502 to produce a collimated optical signal 504 that is directed to a beam splitter 506, which splits the collimated optical signal 504 into a communication signal 508 and a tracking or auxiliary signal 510. In one embodiment, the communication signal 508 comprises approximately 90% of the collimated optical signal 504, but in other embodiments this percentage can vary depending on the beam splitter used. The communication signal 508 is directed, via a primary focusing lens 512, to a high-speed detector 514 that detects the communication signal 508 and generates an electrical signal corresponding to the communication signal. This electrical signal is then input into communication electronics 516 for demodulation and decoding. The high-speed detector 514 may be an InGaAs (Indium-Gallium-Arsenide) detector, an avalanche photodiode, a PIN detector, or some other detector suitable for the data speeds involved in a particular application.

In a receiver where the communication signal 508 comprises 90% of the collimated optical signal 504, the tracking or auxiliary signal 510 correspondingly comprises approximately 10% of the collimated optical signal, but can vary with the percentage directed to the communication signal 508. The tracking or auxiliary signal 510 is directed, via an auxiliary focusing lens 511, to a quad cell detector 518 or other detector that generates a plurality of electrical outputs that are then input to quad cell electronics 520. Although a quad cell detector is illustrated in the present embodiment, other detectors, including single-cell detectors, or multiple-cell detectors having a plurality of cells (e.g., 6 or 8 cells) may also be used in other embodiments. Moreover, in some embodiments a quad cell and its related electronics need not be used at all; the functions performed by the quad cell and associated electronics can instead be performed by the communication detector and its electronics. Using the quad cell does, however, have some advantages. For example, using the quad cell detector 518 results in an increased field of view for detecting the optical signal 126 due to the larger diameter of the quad cell detector 518 in comparison to the high speed communication detector 514. Such a wide field of view may permit the system to function and realign itself even when the system is misaligned by several milliradians. The wide field of view of the quad cell detector 518 also permits the transmission of the auxiliary communication, which may include coordinated acquisition and tracking algorithms, or other system information that allows the system to function more effectively under the particular circumstances.

FIG. 6 illustrates one possible embodiment of the quad cell electronics 520 for use in conjunction with the quad cell detector 518. As shown, the quad cell electronics 520 have two primary functions: detection and monitoring of the carrier tone, and decoding of auxiliary data, if any, in the received optical signal. The quad cell detector 518 generates four electrical outputs 602a-d, one for each of the four cells 518a-d respectively, which are input into a summing junction 604, where the four signals 602a-d are combined to produce a single output signal 606. Each of the four electrical outputs 602a-d corresponds to the magnitude (e.g., the amplitude or power) of the tracking or auxiliary signal 510 (see FIG. 5) incident upon each respective cell 518a-d of the quad cell detector 518. The signals are summed by the summing junction 604 so that regardless of where the signal 510 falls on the quad cell detector 518, there will always be an output signal 606 for input to a signal multiplier 612. For example, the optical signal 510 may, due to a misalignment of the free-space optical terminals, be incident only on a single cell of the quad cell detector 518. Summing the outputs 602a-d ensures an output signal 606.

To determine the frequency of the received carrier tone, the output 606 of the summing junction 604 is routed to a phase-lock loop 608 and a threshold detector 610. The operation of phase-lock loops and threshold detectors is well known to those skilled in the art. Once the frequency of the received carrier tone is determined, it is output to the controller 110. To determine the power of the signal incident on the quad cell 518, the output 606 of the summing junction 604 is directed to the signal multiplier 612 and to the low pass filter 616. Once determined, the quad cell power (QCAC) is output to the controller 110. When the controller has both the frequency of the received tone and the quad cell power, it can operate as shown in FIGS. 2 and 3 to decide whether any adjustments are necessary in the transceiver's operation.

The remaining components of the quad cell electronics 520 are used to demodulate an auxiliary signal 622, if and when present, from the received optical signal 510. The received optical signal 510 corresponding to the data communication signal g(t) is now represented by an output signal 606. The output signal 606 is input into a signal multiplier 612 that combines the output signal 606 with a reference signal r(t), generated by the phase-lock loop 608, to produce a reference output. In an embodiment, the reference signal r(t) comprises a tone with the same frequency (r(t)=B cos(w1t)) as the carrier tone f(t) used for the phase-shift keying of the auxiliary digital signal p(t) described previously in conjunction with the transmitter electronics (see FIG. 4). By multiplying the output signal 606 by the reference signal r(t) having the same frequency w1 as the carrier tone f(t), the reference output is generated that corresponds to the product A·B·s(t)·p(t), and has frequency components 2ω₁ and ω₁

The reference output is input into a filter 614 matched to the auxiliary digital signal p(t), and comprising a function h(t)=p(T₀−t), which filters out the frequency components 2ω₁ and ω₁ referred to above to produce an output signal comprising s(t)·p(t), which may in one embodiment be an on/off keyed signal. The output signal s(t)·p(t) may be thought of as a p(t) signal “envelope” containing the higher frequency s(t) signal therein. A sampler 618 and a threshold detector 620 work in tandem to produce the demodulated auxiliary digital signal 622. The sampler 618, where T=nT₀ and T₀ is equal to the time size of each bit of the auxiliary digital signal p(t), samples each bit of the output signal s(t)·p(t), while the threshold detector 620 acts like a regenerator, determining whether the signal level sampled by sampler 618 is above or below a specified threshold, and assigning a digital “1” or a digital “0” based on this condition. Where the sampled signal is above the specified threshold, a digital 1 is assigned, and where the sampled signal is below the threshold, a digital 0 is assigned. As previously mentioned, this same demodulation technique could be implemented using the high-speed detector 514 instead of the quad cell 518 (see FIG. 5).

In addition to demodulating the auxiliary digital signal p(t), when present, to retrieve the auxiliary data 622, in an alternative embodiment the four electrical outputs 602a-d can each be individually directed to a low-pass filter/amplifier 624 to produce a cell signal for each respective quadrant of the quad cell detector 518, for example, the “d” quadrant signal 602d. Each cell signal (e.g., the “d” quadrant signal) provides an indication of the strength of the optical signal incident on that quadrant of the quad cell detector 518, which in turn provides an indication of the alignment between the transmitting terminal and the receiving terminal of the free-space optical communication system. Optimally, the optical signal will be centered on the quad cell detector 518 such that each respective quadrant 518a-d receives an identical portion of the incident optical signal, and consequently produces an identical cell signal. Electronics (not illustrated) compare the four cell signals generated by the four respective quadrants 518a-d of the quad cell detector 518, and provides relevant information to a steering mechanism (not shown) that can adjust the tracking and alignment of the terminals to provide a better communication channel for data transmission.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A transceiver comprising:
a transmitter to transmit a first signal, the first signal comprising a first data signal modulated onto a first carrier tone;
a receiver to receive a second signal and monitor a characteristic of the second signal, the second signal comprising a second data signal modulated onto a second carrier tone; and
a controller coupled to the transmitter and the receiver to change the frequency of the first carrier tone from a first frequency to a second frequency in response to the monitored characteristic of the second signal.

2. The transceiver of claim 1 wherein the characteristic of the second signal comprises the frequency of the second carrier tone or the power of the second data signal.

3. The transceiver of claim 1 wherein the first frequency is greater than the second frequency.

4. The transceiver of claim 1 wherein the first frequency is less than the second frequency.

5. The transceiver of claim 1 wherein the frequency of the first carrier tone is slowly changed from the first frequency to the second frequency.

6. The transceiver of claim 1 wherein the change from the first frequency to the second frequency occurs at a rate that assures a phase-lock loop will not lose the tone.

7. The transceiver of claim 1 wherein the change in frequency of the first carrier tone causes a change in the monitored characteristic of the second signal.

8. The transceiver of claim 1 wherein the first and second signals further comprise an auxiliary data signal.

9. The transceiver of claim 1 wherein the transceiver is part of a free-space optical communication system and wherein the first and second signals are optical signals.

10. The transceiver of claim 1 wherein the transceiver is part of a fiber-based optical communication system and wherein the first and second signals are optical signals.

11. The transceiver of claim 1 wherein the transceiver is part of a millimeter-wave communication system and wherein the first and second signals are millimeter-wave signals.

12. A process comprising:
transmitting a first signal, the first signal comprising a first data signal modulated onto a first carrier tone;
receiving a second signal, the second signal comprising a second data signal modulated onto a second carrier tone;
monitoring a characteristic of the second signal; and
changing the frequency of the first carrier tone from a first frequency to a second frequency in response to changes in the monitored characteristic of the second signal.

13. The process of claim 12 wherein the characteristic of the second signal comprises the frequency of the second carrier tone or the power of the second data signal.

14. The process of claim 12 wherein the first frequency is greater than the second frequency.

15. The process of claim 12 wherein the first frequency is less than the second frequency.

16. The process of claim 12 wherein the frequency of the first carrier tone is slowly changed from the first frequency to the second frequency.

17. The process of claim 12 wherein changing from the first frequency to the second frequency occurs at a rate that assures a phase-lock loop will not lose the tone.

18. The process of claim 12, further comprising changing the monitored characteristic of the second signal in response to the change in frequency of the first carrier tone.

19. The process of claim 12, further comprising modulating an auxiliary data signal into the first and second signals.

20. The process of claim 11 wherein the first and second signals are optical signals.

21. The process of claim 11 wherein the first and second signals are millimeter-wave signals.

22. A communication system comprising:
a first transceiver comprising:
a first transmitter for transmitting a first signal, the first signal including a first carrier tone,
a first receiver for receiving a second signal and monitoring a characteristic of the second signal, the second signal including a second carrier tone modulated thereon, and
a controller coupled to the first transmitter and the first receiver to change the frequency of the first carrier tone from a first frequency to a second frequency in response to the monitored characteristic of the second signal; and
a second transceiver comprising:
a second transmitter for transmitting the second signal,
a second receiver for receiving the first signal and monitoring a characteristic of the first signal, and
a controller coupled to the second transmitter and the second receiver to change the frequency of the second carrier tone from the first frequency to the second frequency, and to change the characteristic of the first signal in response to the change of frequency of the first carrier tone.

23. The system of claim 22 wherein the characteristic of the second signal comprises the frequency of the second carrier tone or the power of the second data signal.

24. The system of claim 22 wherein the first frequency is greater than the second frequency.

25. The system of claim 22 wherein the first frequency is less than the second frequency.

26. The system of claim 22 wherein the frequency of the first carrier tone is slowly changed from the first frequency to the second frequency.

27. The system of claim 22 wherein the change from the first frequency to the second frequency occurs at a rate that assures a phase-lock loop will not lose the tone.

28. The system of claim 22 wherein the change in frequency of the first carrier tone causes a change in the monitored characteristic of the second signal.

29. The system of claim 22 wherein the first and second signals further comprise an auxiliary data signal.

30. The system of claim 22 wherein the first and second transceivers are free-space optical transceivers and wherein the first and second signals are optical signals.

31. The system of claim 22 wherein the first and second transceivers are optical fiber based transceivers and wherein the first and second signals are optical signals.

32. The system of claim 22 wherein the first and second transceivers are millimeter-wave transceivers and wherein the first and second signals are millimeter-wave signals.

33. A process comprising:
in a first transceiver:
transmitting a first signal, the first signal including a first carrier tone modulated thereon,
receiving a second signal, the second signal including a second carrier tone modulated thereon,
monitoring a characteristic of the second signal, and
changing the frequency of the first carrier tone from a first frequency to a second frequency in response to the monitored characteristic of the second signal and changing the monitored characteristic of the first signal in response to the change of frequency of the second carrier tone; and
in a second transceiver:
receiving the first signal,
transmitting the second signal,
monitoring a characteristic of the first signal, and
changing the frequency of the second carrier tone from the first frequency to the second frequency in response to the monitored characteristic of the first signal, and changing the monitored characteristic of the second signal in response to the change of frequency of the first carrier tone.

34. The process of claim 33 wherein the characteristic of the second signal comprises the frequency of the second carrier tone or the power of the second data signal.

35. The process of claim 33 wherein the first frequency is greater than the second frequency.

36. The process of claim 33 wherein the first frequency is less than the second frequency.

37. The process of claim 33 wherein the frequency of the first carrier tone is slowly changed from the first frequency to the second frequency.

38. The process of claim 33 wherein changing from the first frequency to the second frequency occurs at a rate that assures a phase-lock loop will not lose the tone.

39. The process of claim 33, further comprising changing the monitored characteristic of the second signal in response to the change in frequency of the first carrier tone.

40. The process of claim 33, further comprising modulating an auxiliary data signal into the first and second signals.

41. The system of claim 33 wherein the first and second transceivers are free-space optical transceivers and wherein the first and second signals are optical signals.

42. The system of claim 33 wherein the first and second transceivers are millimeter-wave transceivers and wherein the first and second signals are millimeter-wave signals.
